(19) United States
(12) Patent Application Publication
(10) Pub. No.: US 2024/0302267 A1
(43) Pub. Date: Sep. 12, 2024

(54) OPTICAL DEVICE

(71) Applicant: Panasonic Intellectual Property Management Co., Ltd., Osaka (JP)

(72) Inventors: Taku OTANI, Aichi (JP); Hideto MOTOMURA, Kyoto (JP)

(21) Appl. No.: 18/261,390

(22) PCT Filed: Dec. 21, 2022
(86) PCT No.: PCT/JP2021/047355

§ 371 Date: Jul. 13, 2023

(30) Foreign Application Priority Data
Feb. 12, 2021 (JP) 2021-021026

(51) Int. Cl. G01N 21/27; G01N 21/88

(52) U.S. Cl. CPC G01N 21/27; G01N 21/8806; G01N 2021/8845; G01N 2021/8848

(57) ABSTRACT

An optical device includes a first light source that emits first light, a second light source that emits second light, first and second polarizing beam splitters, a dichroic mirror, a quarter-wave plate that changes the polarization state of light that passes through, a hyperspectral camera, and a visible light camera. The first polarizing beam splitter, the quarter-wave plate, and the dichroic mirror are disposed in an optical path of the first light in stated order. The second polarizing beam splitter and the dichroic mirror are disposed in an optical path of the second light in stated order. The hyperspectral camera receives first specularly reflected light out of first reflected light. The visible light camera receives second diffused light out of second reflected light.

### CROSS-REFERENCE OF RELATED APPLICATIONS

This application is the U.S. National Phase under 35 U.S.C. § 371 of International Patent Application No. PCT/JP2021/047355, filed on Dec. 21, 2021, which in turn claims the benefit of Japanese Patent Application No. 2021-021026, filed on Feb. 12, 2021, the entire disclosures of which Applications are incorporated by reference herein.

### TECHNICAL FIELD

The present disclosure relates to optical devices.

### BACKGROUND ART

Patent Literature (PTL) 1 discloses a learning device that generates a learning model used for product inspection. The learning device disclosed in PTL 1 includes a first camera that acquires image data on a sample and a second camera that acquires physical property information on the sample. The learning device generates teacher data using the image data and the physical property information and generates a learning model by machine learning using the generated teacher data.

### CITATION LIST

### Patent Literature

[PTL 1] WO 2019/230356

### SUMMARY OF INVENTION

### Technical Problem

The learning device disclosed in PTL 1 needs the sample to be moved when images of the sample are captured by the two cameras arranged side by side. This causes a problem of misalignment of images obtained by the two cameras.

Moreover, both the two cameras receive specularly reflected light and diffused light from the sample. One of the specularly reflected light or the diffused light causes a problem of noise in the images.

The present disclosure provides an optical device that can produce multiple images with little image misalignment and with reduced noise.

### Solution to Problem

An optical device according to an aspect of the present disclosure includes a first light source that emits first light in a first wavelength band; a second light source that emits second light in a second wavelength band different from the first wavelength band; a first polarizing beam splitter; a second polarizing beam splitter; a beam splitter; a first polarizer that changes the polarization state of light that passes through; a first imager having a sensitivity to the first wavelength band; and a second imager having a sensitivity to the second wavelength band. The first polarizing beam splitter, the first polarizer, and the beam splitter are disposed in an optical path of the first light in stated order. The second polarizing beam splitter and the beam splitter are disposed in an optical path of the second light in stated order. The first imager receives, out of first reflected light, light that has passed through the beam splitter, the first polarizer, and the first polarizing beam splitter in stated order, the first reflected light resulting from the first light that has exited from the beam splitter being reflected from an object. The second imager receives, out of second reflected light, light that has passed through the beam splitter and the second polarizing beam splitter in stated order, the second reflected light resulting from the second light that has exited from the beam splitter being reflected from the object. The beam splitter transmits one of a pair of the first light and the first reflected light or a pair of the second light and the second reflected light, and reflects an other pair of the pair of the first light and the first reflected light or the pair of the second light and the second reflected light.

### Advantageous Effects of Invention

According to the present disclosure, multiple images with little image misalignment and with reduced noise can be obtained.

### BRIEF DESCRIPTION OF DRAWINGS

FIG. 1 illustrates an overall configuration of an optical device according to Embodiment 1.

FIG. 2 illustrates a specific configuration of the optical device according to Embodiment 1.

FIG. 3 illustrates a specific configuration of an optical device according to Embodiment 2.

FIG. 4 illustrates an overall configuration of an optical device according to Embodiment 3.

FIG. 5 illustrates a specific configuration of the optical device according to Embodiment 3.

FIG. 6 illustrates a specific configuration of an optical device according to Embodiment 4.

### DESCRIPTION OF EMBODIMENTS

### (Overview of the Present Disclosure)

An optical device according to an aspect of the present disclosure includes a first light source that emits first light in a first wavelength band; a second light source that emits second light in a second wavelength band different from the first wavelength band; a first polarizing beam splitter; a second polarizing beam splitter; a beam splitter; a first polarizer that changes the polarization state of light that passes through; a first imager having a sensitivity to the first wavelength band; and a second imager having a sensitivity to the second wavelength band. The first polarizing beam splitter, the first polarizer, and the beam splitter are disposed in an optical path of the first light in stated order. The second polarizing beam splitter and the beam splitter are disposed in an optical path of the second light in stated order. The first imager receives, out of first reflected light, light that has passed through the beam splitter, the first polarizer, and the first polarizing beam splitter in stated order, the first reflected light resulting from the first light that has exited from the beam splitter being reflected from an object. The second imager receives, out of second reflected light, light that has passed through the beam splitter and the second polarizing beam splitter in stated order, the second reflected light resulting from the second light that has exited from the beam splitter being reflected from the object. The beam splitter transmits one of a pair of the first light and the first reflected light or a pair of the second light and the second reflected light, and reflects an other pair of the pair of the first light and the first reflected light or the pair of the second light and the second reflected light.

In this manner, the first imager and the second imager receive reflected lights that have passed through the corresponding polarizing beam splitters. The polarizing beam splitters can emit lights from which one of specularly reflected light or diffused light, which causes noise, is removed to the corresponding imagers. Thus, multiple images with reduced noise can be obtained. That is, the SN ratios (Signal-to-Noise Ratios) of the multiple images can be improved.

Moreover, the first light and the second light, with the optical axes equated by the beam splitter, are emitted to the object. That is, the beam splitter can equate the optical axes of multiple lights emitted from the optical device. As a result, the object does not need to be moved, preventing image misalignment.

Moreover, the reflected lights from the object enter the beam splitter, and outgoing lights are emitted to the corresponding imagers. That is, the optical axes of the reflected lights and the optical axes of the outgoing lights can be equated. Thus, the imagers can expose the object to the lights from in front and can receive the reflected lights produced by the lights. Exposing the object to the lights from in front increases the in-plane uniformity of the lights.

Moreover, making the two optical systems coaxial can also reduce the size of the optical device. Furthermore, the use of the polarizing beam splitters reduces light loss compared with a case where one-way mirrors are used, and thus also contributes to a reduction in power consumption.

Thus, the optical device according to this aspect can obtain multiple images with little image misalignment and with reduced noise. Furthermore, the optical device according to this aspect can emit light with a high in-plane uniformity to an object and can also contribute to a reduction in the size and power consumption of the device.

Moreover, for example, the beam splitter may be a dichroic mirror that has a reflection band that is the first wavelength band and a transmission band that is the second wavelength band.

Thus, multiple images with little image misalignment and with reduced noise can be obtained. Furthermore, the optical device according to this aspect can emit light with a high in-plane uniformity to an object and can also contribute to a reduction in the size of the device.

Moreover, for example, the first polarizer may be a quarter-wave plate.

Thus, the function of the polarizer can be achieved using one member, reducing the number of parts of the optical device and thus contributing to a reduction in the size of the optical device.

Moreover, for example, the first polarizer may include a first Faraday rotator and a first half-wave plate, and the first Faraday rotator and the first half-wave plate may be disposed in the optical path of the first light in stated order.

Thus, the function of the polarizer can be achieved using two members, increasing the flexibility in the configuration of the polarizer.

Moreover, for example, the first imager may be a multispectral camera.

Thus, the reflected light from the object can be spectroscopically analyzed for each wavelength. Accordingly, the optical device according to this aspect is useful for, for example, object inspection.

Moreover, for example, the second imager may be a camera having a sensitivity to visible light.

Thus, the optical device according to this aspect can obtain visible light images of the object and is thus useful for, for example, visual inspection of objects.

Moreover, for example, an optical device according to an aspect may further include a second polarizer that changes the polarization state of light that passes through, and the second polarizer may be disposed between the second polarizing beam splitter and the beam splitter in the optical path of the second light.

Thus, multiple images with little image misalignment and with reduced noise can be obtained. Furthermore, the optical device according to this aspect can emit light with a high in-plane uniformity to an object and can also contribute to a reduction in the size of the device.

Moreover, for example, the second polarizer may be a quarter-wave plate.

Thus, the function of the polarizer can be achieved using one member, reducing the number of parts of the optical device and thus contributing to a reduction in the size of the optical device.

Moreover, for example, the second polarizer may include a second Faraday rotator and a second half-wave plate, and the second Faraday rotator and the second half-wave plate may be disposed in the optical path of the second light in stated order.

Thus, the function of the polarizer can be achieved using two members, increasing the flexibility in the configuration of the polarizer.

Moreover, for example, the second imager may be a multispectral camera.

Thus, the optical device according to this aspect can perform spectroscopic analysis in a wider wavelength range and is thus useful for, for example, visual inspection of more various objects.

Hereinafter, embodiments will be described in detail with reference to the drawings.

Note that each of the embodiments described below illustrates a general or specific example. The numerical values, shapes, materials, elements, positions and connections of the elements, steps, order of steps, and the like shown in the following embodiments are mere examples and are not intended to limit any aspect of the present disclosure. Moreover, among the elements in the following embodiments, those that are not recited in any of the independent claims are described as optional elements.

Moreover, each drawing is a schematic diagram and is not necessarily illustrated in precise dimensions. Thus, for example, the drawings are not necessarily drawn on the same scale. Moreover, substantially identical configurations are given the same reference signs throughout the drawings, and duplicate explanations are omitted or simplified.

Moreover, in this description, terms that indicate the relationships between elements such as being identical or coincident, illustrated shapes, and numerical ranges are not expressions representing exact meanings only, but are expressions meaning that substantially equivalent ranges, for example, differences of about several percent, are also included.

Moreover, in this description, the “optical axis” of light refers to the central axis of a long stretch of light. The optical axis of light of which the expanse is small substantially coincides with the traveling direction and the optical path of the light. A line formed by continuously connecting, along the traveling direction, center points of radiation areas of light in imaginary planes orthogonal to the traveling direction can be regarded as the optical axis and the optical path.

Moreover, in this description, “passage” of light refers to an event where at least part of light enters a member serving as a target and where at least part of the incident light is emitted from the member. Moreover, in this description, unless otherwise noted, “transmission” of light is used for “passage” of light through a member serving as a target with the traveling direction of the light unchanged.

Moreover, in this description, unless otherwise noted, the use of ordinal numbers, such as “first” and “second”, is to avoid confusion among elements of the same kind and to distinguish respective elements rather than to denote the number or the order of those elements.

### Embodiment 1

### [1-1. Overview]

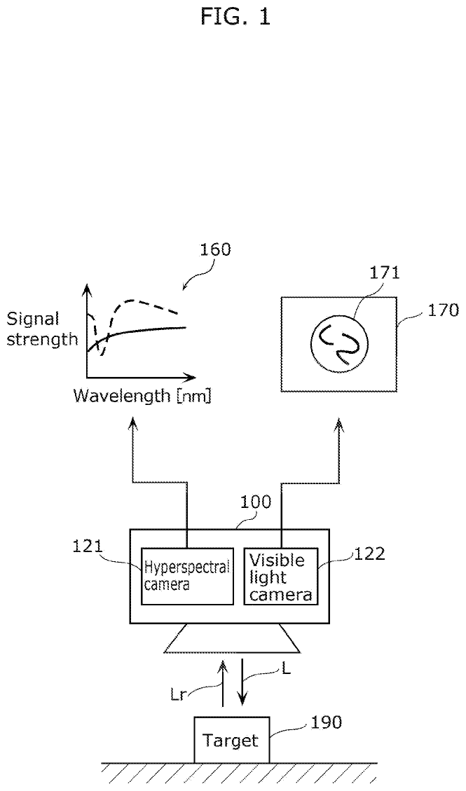

First, an optical device according to Embodiment 1 will be described with reference to FIG. 1. FIG. 1 illustrates an overall configuration of optical device 100 according to this embodiment.

Optical device 100 illustrated in FIG. 1 emits outgoing light L to target 190 and receives reflected light Lr resulting from the reflection of outgoing light L by target 190. Optical device 100 generates and outputs information used for inspection of target 190 on the basis of received reflected light Lr.

Specifically, optical device 100 generates and outputs object information 160 and image 170.

Object information 160 indicates, for example, spectroscopy spectra of reflected light Lr in corresponding parts of target 190. The composition of target 190 can be analyzed, or foreign substances contained in target 190 can be detected on the basis of object information 160.

Image 170 is a visible light image representing the external appearance of target 190. Image 170 contains object image 171 representing target 190. For example, the external appearance of target 190 can be visually inspected on the basis of object image 171.

Note that target 190 is an example of an object of which images are captured by optical device 100. For example, target 190 includes, but not limited in particular to, foods, medicines, and industrial products.

### [1-2. Configuration]

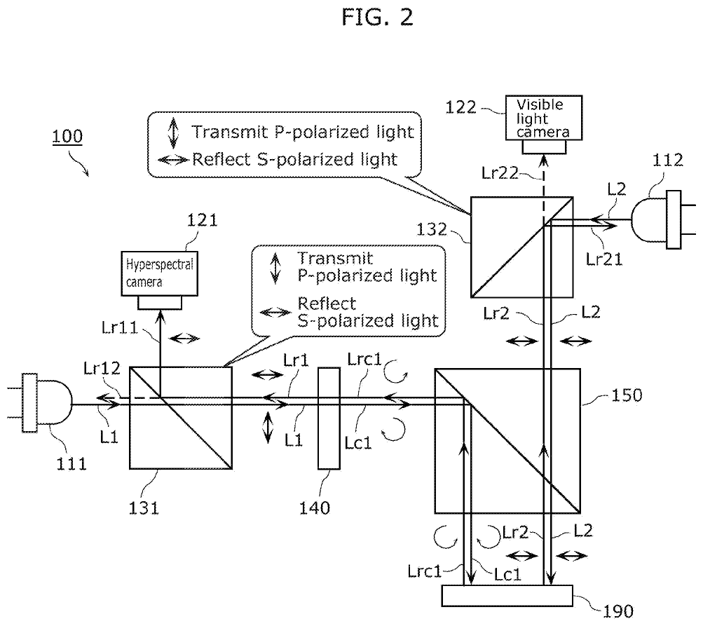

Next, a specific configuration of optical device 100 according to this embodiment will be described with reference to FIG. 2. FIG. 2 illustrates the specific configuration of optical device 100 according to this embodiment.

As illustrated in FIG. 2, optical device 100 includes first light source 111, second light source 112, hyperspectral camera 121, visible light camera 122, polarizing beam splitters 131 and 132, quarter-wave plate 140, and dichroic mirror 150.

First light source 111 emits first light L1 in a first wavelength band. First light L1 has a peak wavelength at which the emission intensity is the maximum within the first wavelength band. For example, first light L1 has an intensity of 10% or more of the intensity of first light L1 at the peak wavelength across the entire range of the first wavelength band.

For example, first light L1 is ultraviolet light. That is, the first wavelength band is, for example, an ultraviolet light band. Specifically, the first wavelength band ranges from 100 nm to 380 nm, although not limited thereto. The first wavelength band may include a visible light band and/or an infrared light band in addition to or instead of the ultraviolet light band.

For example, first light source 111 is an LED (Light Emitting Diode) or a laser device, although not limited thereto. First light source 111 may be a discharge lamp.

Second light source 112 emits second light L2 in a second wavelength band. Second light L2 has a peak wavelength at which the emission intensity is the maximum within the second wavelength band. For example, second light L2 has an intensity of 10% or more of the intensity of second light L2 at the peak wavelength across the entire range of the second wavelength band.

For example, second light L2 is visible light. Note that second light L2 may include near-infrared light or infrared light. That is, the second wavelength band is, for example, a visible light band and may include a near-infrared light band or a band of wavelengths longer than the wavelengths of the near-infrared light. Specifically, the second wavelength band ranges from 380 nm to 780 nm, although not limited thereto.

For example, second light source 112 is an LED or a laser device, although not limited thereto. Second light source 112 may be a discharge lamp.

Hyperspectral camera 121 is an example of a first imager having a sensitivity to the first wavelength band. Specifically, hyperspectral camera 121 is an example of a multispectral camera that obtains the intensity of incident light in each wavelength band.

The number of wavelength bands (that is, the number of bands) hyperspectral camera 121 can obtain is, for example, 10 or more and may be 100 or more. The widths of the wavelength bands are, for example, 10 nm or less and may be 5 nm or less.

Hyperspectral camera 121 can obtain image data for each wavelength band. Hyperspectral camera 121 can also obtain spectroscopy spectra in corresponding pixels on the basis of the image data. For example, object information 160 illustrated in FIG. 1 indicates spectroscopy spectra of two pixels, which are indicated by a solid line and a dashed line, in the image data in a graph area with the horizontal axis representing the wavelength and the vertical axis representing the signal strength (light intensity). The component of each pixel can be determined by the differences in spectroscopy spectrum.

Visible light camera 122 is an example of a second imager having a sensitivity to the second wavelength band. Specifically, visible light camera 122 is a camera, such as an RGB camera, having a sensitivity to visible light. Note that visible light camera 122 may have a sensitivity to infrared light (IR) in addition to or instead of visible light.

Polarizing beam splitter 131 is an example of a first polarizing beam splitter. Note that the polarizing beam splitter is an optical element that splits incident light into S-polarized light and P-polarized light and that emits these lights in directions different from each other. Polarizing beam splitter 131 reflects S-polarized light and transmits P-polarized light.

Polarizing beam splitter 132 is an example of a second polarizing beam splitter. Polarizing beam splitter 132 reflects S-polarized light and transmits P-polarized light.

Quarter-wave plate 140 is an example of a first polarizer that changes the polarization state of light that passes through. Specifically, quarter-wave plate 140 shifts the phase of incident light by a quarter wavelength when emitting the incident light. In this embodiment, quarter-wave plate 140 converts linearly polarized light into circularly polarized light and circularly polarized light into linearly polarized light.

The polarization direction of linearly polarized light that enters (or exits from) quarter-wave plate 140 changes the rotation direction of circularly polarized light that exits from (or enters) quarter-wave plate 140. For example, as illustrated in FIG. 2, P-polarized first light L1 passes through quarter-wave plate 140 to be converted into circularly polarized first light Lc1 rotated clockwise. In contrast, circularly polarized first reflected light Lrc1 rotated counterclockwise passes through quarter-wave plate 140 to be converted into S-polarized first reflected light Lr1.

Dichroic mirror 150 is an example of a beam splitter that transmits one of a pair of first light Lc1 and first reflected light Lrc1 or a pair of second light L2 and second reflected light Lr2 and that reflects the other pair. Specifically, dichroic mirror 150 has one of the first wavelength band or the second wavelength band as a transmission band and the other of the first wavelength band and the second wavelength band as a reflection band. In this embodiment, dichroic mirror 150 has the reflection band that is the first wavelength band and the transmission band that is the second wavelength band. Dichroic mirror 150 is an optical element that splits incident light according to the wavelengths and that emits the lights in directions different from each other.

### [1-3. Layout of Elements]

Next, the layout of elements included in optical device 100 will be described with reference to FIG. 2.

As illustrated in FIG. 2, polarizing beam splitter 131, quarter-wave plate 140, and dichroic mirror 150 are disposed in an optical path of first light L1. In this embodiment, first light source 111, polarizing beam splitter 131, quarter-wave plate 140, and dichroic mirror 150 are collinear.

Here, the optical path of first light L1 refers to a path along which the main component of first light L1 travels after first light L1 is emitted from first light source 111 until first light L1 reaches target 190. Specifically, the optical path of first light L1 is a path along which first lights L1 and Lc1 illustrated in FIG. 2 travel. The optical path of first light L1 is bent at a right angle at dichroic mirror 150. That is, the reflective surface of dichroic mirror 150 is inclined at 45° with respect to the traveling direction of first light L1 (first reflected light Lrc1).

Hyperspectral camera 121 is disposed on a side of polarizing beam splitter 131 with respect to the straight line along which polarizing beam splitter 131 and dichroic mirror 150 are aligned. That is, the straight line connecting hyperspectral camera 121 and polarizing beam splitter 131 is orthogonal to the straight line connecting polarizing beam splitter 131 and dichroic mirror 150. The reflective surface of polarizing beam splitter 131 is inclined at 45° with respect to the traveling direction of first reflected light Lr1 (first light L1).

Polarizing beam splitter 132 and dichroic mirror 150 are disposed in an optical path of second light L2. In this embodiment, visible light camera 122, polarizing beam splitter 132, dichroic mirror 150, and target 190 are collinear. Note that the reflective surface of dichroic mirror 150 is inclined at 45° with respect to the traveling direction of second light L2 (second reflected light Lr2).

Second light source 112 is not disposed on the straight line along which polarizing beam splitter 132 and dichroic mirror 150 are aligned. Second light source 112 is disposed on a side of polarizing beam splitter 132 with respect to the straight line along which polarizing beam splitter 132 and dichroic mirror 150 are aligned. That is, the straight line connecting second light source 112 and polarizing beam splitter 132 is orthogonal to the straight line connecting polarizing beam splitter 132 and dichroic mirror 150. The reflective surface of polarizing beam splitter 132 is inclined at 45° with respect to the traveling direction of second light L2 (second reflected light Lr2).

Note that, when optical device 100 is in use, target 190 is disposed in front of the exit port (not illustrated) of outgoing light L emitted from optical device 100. Accordingly, “polarizing beam splitter 132, dichroic mirror 150, and target 190 are collinear” is synonymous with “polarizing beam splitter 132, dichroic mirror 150, and the exit port of optical device 100 are collinear”.

Here, the optical path of second light L2 refers to a path along which the main component of second light L2 travels after second light L2 is emitted from second light source 112 until second light L2 reaches target 190. As illustrated in FIG. 2, the optical path of second light L2 is bent at a right angle at polarizing beam splitter 132.

The elements of optical device 100 are stored inside an outer casing with light-blocking properties, for example. The outer casing is provided with an exit port from which light is emitted to target 190 and an entry port through which reflected light from target 190 enters. Although not illustrated, the exit port and the entry port are, for example, one opening.

A trapping structure for absorbing leaking light, which is a major factor of noise, may be disposed inside the outer casing.

Moreover, a black light-absorbing surface may be provided for the inner surface of the outer casing to accelerate the absorption of leaking light.

### [1-4. Optical Paths]

Next, the optical paths of light inside optical device 100 will be described with reference to FIG. 2.

In FIG. 2, the traveling direction of each light is indicated by a one-way arrow. Moreover, two-way arrows located adjacent to the one-way arrows indicate that the lights are linearly polarized lights.

In the drawings, vertical arrows indicate P-polarized lights, whereas horizontal arrows indicate S-polarized lights. Similarly, arc-shaped arrows located adjacent to the one-way arrows indicate that the lights are circularly polarized lights.

In FIG. 2, first light Lc1 and second light L2 are drawn as if these lights are emitted to target 190 from different positions in dichroic mirror 150. This is for ease of understanding the path of each light. In practice, first light Lc1 and second light L2 exit from substantially the same point. Outgoing light L illustrated in FIG. 1 is first light Lc1 and/or second light L2. That is, the optical axis of first light Lc1 and the optical axis of second light L2 are substantially the same.

Similarly, in practice, first light Lc1 exits from a point in dichroic mirror 150, and first reflected light Lrc1 enters dichroic mirror 150 at substantially the same point. That is, the optical axis of first light Lc1 and the optical axis of first reflected light Lrc1 are substantially the same. Similarly, the optical axis of first light L1 and the optical axis of first reflected light Lr1 are substantially the same. The optical axis of second light L2 and the optical axis of second reflected light Lr2 are substantially the same.

Since the optical axes of the lights are equated in this manner, target 190 does not need to be moved, preventing image misalignment. The imagers can expose target 190 to the lights from in front and can receive the reflected light produced by the lights. Exposing target 190 to the lights from in front increases the in-plane uniformity of the lights.

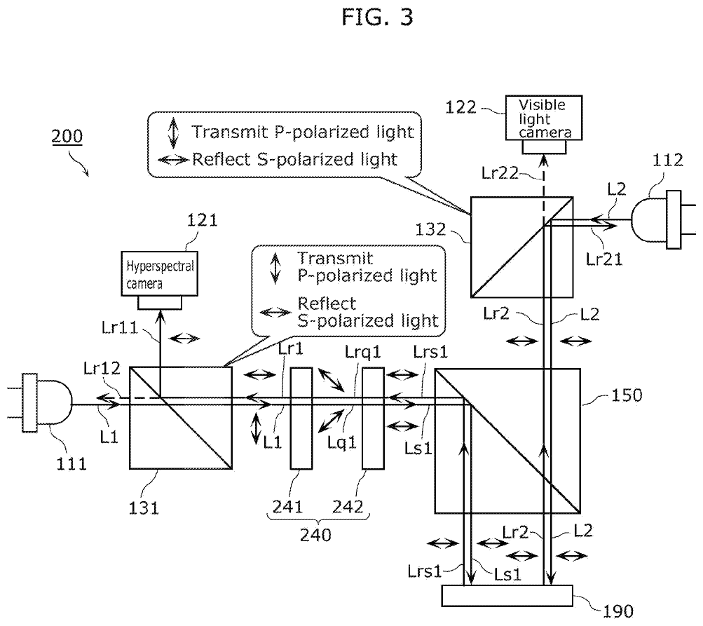

Note that elements in FIGS. 3, 5, and 6 described below are illustrated similarly to the above.

### [1-4-1. First Light and First Reflected Light]

As illustrated in FIG. 2, first light L1 is emitted from first light source 111 and enters polarizing beam splitter 131. Polarizing beam splitter 131 reflects S-polarized light and transmits P-polarized light. Accordingly, first light L1 exiting from polarizing beam splitter 131 is P-polarized light. Note that the S-polarized light reflected from polarizing beam splitter 131 is not illustrated. The S-polarized light is leaking light and is absorbed inside the outer casing of optical device 100, for example.

First light L1 exiting from polarizing beam splitter 131 passes through quarter-wave plate 140 to be converted into circularly polarized first light Lc1. Circularly polarized first light Lc1 is reflected from dichroic mirror 150 and is emitted to target 190.

Circularly polarized first light Lc1 is reflected by target 190. The reflection includes specular reflection and diffuse reflection. The reflection causes first reflected light Lrc1 to be generated from target 190. First reflected light Lrc1 includes circularly polarized light. However, the rotation direction of the circularly polarized light is opposite to that of first light Lc1. This is because the rotation direction of circularly polarized light is reversed when the circularly polarized light is specularly reflected from an object. The circularly polarized light included in first reflected light Lrc1 is a component resulting from specular reflection (that is, specularly reflected light) from target 190.

Note that first reflected light Lrc1 also includes a component resulting from diffuse reflection (that is, diffused light) from target 190. Diffuse reflection causes light to be polarized irregularly, causing the polarization state of the diffused light included in first reflected light Lrc1 to be random.

After being reflected from dichroic mirror 150, first reflected light Lrc1 passes through quarter-wave plate 140. The circularly polarized light included in first reflected light Lrc1 is converted into linearly polarized light. At this moment, the rotation direction of the circularly polarized light included in first reflected light Lrc1 is opposite to that of first light Lc1. Accordingly, first reflected light Lr1 that has passed through quarter-wave plate 140 includes S-polarized light as specularly reflected light. Note that the polarization state of the diffused light included in first reflected light Lrc1 remains random after the diffused light passes through quarter-wave plate 140.

First reflected light Lr1 exiting from quarter-wave plate 140 enters polarizing beam splitter 131. Polarizing beam splitter 131 reflects S-polarized light and transmits P-polarized light. Accordingly, first specularly reflected light Lr11 out of first reflected light Lr1 is reflected from polarizing beam splitter 131 and enters hyperspectral camera 121. First diffused light Lr12 out of first reflected light Lr1 passes through polarizing beam splitter 131 on an as-is basis. First diffused light Lr12 is emitted to first light source 111 and absorbed by, for example, the inner surface of optical device 100. Note that light-blocking walls may be provided to prevent first diffused light Lr12 from entering hyperspectral camera 121 and visible light camera 122.

In this manner, hyperspectral camera 121 receives, out of first reflected light Lrc1, first specularly reflected light Lr11 that has passed through dichroic mirror 150, quarter-wave plate 140, and polarizing beam splitter 131 in stated order. Specifically, only first specularly reflected light Lr11, which is the component resulting from the specular reflection from target 190, enters hyperspectral camera 121.

Here, first specularly reflected light Lr11 is stronger than first diffused light Lr12. Accordingly, when a camera having a sensitivity to a wide wavelength band (for example, visible light camera 122) is used, the sensor may reach its light reception limit, and the signal strength may saturate. In contrast, hyperspectral camera 121 obtains the strength in each narrow wavelength band, and thus the intensities of light in individual wavelength bands are low. Accordingly, the signal strength does not saturate easily. As a result, the SN ratio of the image data (spectral data) based on the specularly reflected light from target 190 can be improved.

Note that first diffused light Lr12 includes light from points other than target points on target 190 and easily causes noise. In this embodiment, first diffused light Lr12 does not enter hyperspectral camera 121 easily, and thus the SN ratio of the image data (spectral data) obtained by hyperspectral camera 121 can be improved.

### [1-4-2. Second Light and Second Reflected Light]

As illustrated in FIG. 2, second light L2 is emitted from second light source 112 and enters polarizing beam splitter 132. Polarizing beam splitter 132 reflects S-polarized light and transmits P-polarized light. Accordingly, second light L2 exiting from polarizing beam splitter 132 is S-polarized light. Note that the P-polarized light passing through polarizing beam splitter 132 is not illustrated. The P-polarized light is leaking light and is absorbed inside the outer casing of optical device 100, for example.

Second light L2 exiting from polarizing beam splitter 132 passes through dichroic mirror 150 and is emitted to target 190.

Second light L2 is reflected by target 190. The reflection causes second reflected light Lr2 to be generated from target 190. Second reflected light Lr2 includes S-polarized light. This is because specular reflection maintains linear polarization. The S-polarized light included in second reflected light Lr2 is a component resulting from specular reflection (that is, specularly reflected light) from target 190.

Note that second reflected light Lr2 also includes a component resulting from diffuse reflection (that is, diffused light) from target 190. Diffuse reflection causes light to be polarized irregularly. As a result, the polarization state of the diffused light included in second reflected light Lr2 is random, and the diffused light includes, for example, P-polarized light.

After passing through dichroic mirror 150, second reflected light Lr2 enters polarizing beam splitter 132. Polarizing beam splitter 132 reflects S-polarized light and transmits P-polarized light. Accordingly, second diffused light Lr22 out of second reflected light Lr2 passes through polarizing beam splitter 132 on an as-is basis and enters visible light camera 122. Second specularly reflected light Lr21 out of second reflected light Lr2 is reflected from polarizing beam splitter 132. Second specularly reflected light Lr21 is emitted to second light source 112 and absorbed by, for example, the inner surface of optical device 100. Note that light-blocking walls may be provided to prevent second specularly reflected light Lr21 from entering visible light camera 122 and hyperspectral camera 121.

In this manner, visible light camera 122 receives, out of second reflected light Lr2, light that has passed through dichroic mirror 150 and polarizing beam splitter 132 in stated order. Specifically, only second diffused light Lr22, which is the component resulting from the diffuse reflection from target 190, enters visible light camera 122, and thus visible light images based on second diffused light Lr22 can be created.

Here, second specularly reflected light Lr21 is stronger than second diffused light Lr22. Accordingly, in a case where second specularly reflected light Lr21 enters visible light camera 122, the sensor reaches its light reception limit, and the signal strength saturates, causing so-called whiteout. Since second specularly reflected light Lr21, which causes noise, does not enter visible light camera 122 easily, the SN ratio of the image data obtained by visible light camera 122 can be improved.

### Embodiment 2

Next, Embodiment 2 will be described.

An optical device according to Embodiment 2 differs from that according to Embodiment 1 in the configuration of the polarizer. In the description below, differences from Embodiment 1 will be mainly described, and explanations of points in common will be omitted or simplified.

### [2-1. Configuration]

FIG. 3 illustrates a specific configuration of optical device 200 according to this embodiment. As illustrated in FIG. 3, optical device 200 includes polarizer 240 instead of quarter-wave plate 140 when compared with optical device 100 illustrated in FIG. 2.

Polarizer 240 is an example of the first polarizer that changes the polarization state of light that passes through. Polarizer 240 includes Faraday rotator 241 and half-wave plate 242. Faraday rotator 241 and half-wave plate 242 are disposed in the optical path of first light L1 in stated order.

Faraday rotator 241 is an example of a first Faraday rotator. Faraday rotator 241 is an optical element that rotates the polarization direction of incident light by 45°. The rotation direction is reversed depending on incident directions from which light enters Faraday rotator 241. Thus, as illustrated in FIG. 3, first light L1 passes through Faraday rotator 241 to be converted into first light Lq1 rotated 45° clockwise. In contrast, first reflected light Lrq1 entering from the opposite direction passes through Faraday rotator 241 to be converted into first reflected light Lr1 rotated 45° counterclockwise.

Half-wave plate 242 is an example of a first half-wave plate. As is Faraday rotator 241, half-wave plate 242 is an optical element that rotates the polarization direction of incident light by 45°. Note that the rotation direction of half-wave plate 242 is fixed regardless of the incident directions of light. Thus, as illustrated in FIG. 3, first light Lq1 passes through half-wave plate 242 to be converted into first light Ls1 rotated 45° clockwise. In contrast, first reflected light Lrs1 entering from the opposite direction is converted into first reflected light Lrq1 rotated 45° clockwise, which is the same rotation direction.

Note that the direction in which Faraday rotator 241 rotates the polarization direction and the direction in which half-wave plate 242 rotates the polarization direction are the same when light passes through Faraday rotator 241 and half-wave plate 242 in stated order (first light L1 illustrated in FIG. 3). Thus, first light L1 passes through Faraday rotator 241 and half-wave plate 242 in stated order to be light of which the polarization direction is rotated 90°. In contrast, for first reflected light Lrs1 entering from the opposite direction, Faraday rotator 241 cancels the rotation of the polarization direction by half-wave plate 242. Thus, passage through half-wave plate 242 and Faraday rotator 241 in stated order does not change the polarization direction of first reflected light Lrs1.

### [2-2. Optical Paths]

Next, the optical paths of light inside optical device 200 will be described with reference to FIG. 3. Note that the second light and the second reflected light are the same as in Embodiment 1. Therefore, the first light and the first reflected light will be described below.

As illustrated in FIG. 3, first light L1 emitted from first light source 111 and passing through polarizing beam splitter 131 passes through Faraday rotator 241 to be converted into first light Lq1 of which the polarization direction is rotated 45° clockwise. First light Lq1 exiting from Faraday rotator 241 passes through half-wave plate 242 to be converted into first light Ls1 further rotated 45° in the same direction. Thus, P-polarized first light L1 passes through polarizer 240 to be converted into S-polarized first light Ls1. S-polarized first light Ls1 is reflected from dichroic mirror 150 and is emitted to target 190.

S-polarized first light Ls1 is reflected by target 190. The reflection causes first reflected light Lrs1 to be generated from target 190. First reflected light Lrs1 includes S-polarized light. This is because specular reflection maintains linear polarization. The S-polarized light included in first reflected light Lrs1 is a component resulting from specular reflection (that is, specularly reflected light) from target 190.

Note that first reflected light Lrs1 also includes a component resulting from diffuse reflection (that is, diffused light) from target 190. Diffuse reflection causes light to be polarized irregularly, causing the polarization state of the diffused light included in first reflected light Lrs1 to be random.

After being reflected from dichroic mirror 150, first reflected light Lrs1 passes through half-wave plate 242 to be converted into first reflected light Lrq1 of which the polarization direction is rotated 45°. First reflected light Lrq1 exiting from half-wave plate 242 passes through Faraday rotator 241 to be converted into first reflected light Lr1 of which the polarization direction is rotated 45° in the direction opposite to the rotation direction by half-wave plate 242. That is, the polarization direction of first reflected light Lr1 exiting from Faraday rotator 241 is the same as the polarization direction of first reflected light Lrs1 before first reflected light Lrs1 enters half-wave plate 242.

The polarization state of first reflected light Lr1 exiting from Faraday rotator 241 is the same as the polarization state of first reflected light Lr1 exiting from quarter-wave plate 140 according to Embodiment 1. Accordingly, as in Embodiment 1, out of first reflected light Lr1, first specularly reflected light Lr11 that has entered polarizing beam splitter 131 is reflected from polarizing beam splitter 131 and enters hyperspectral camera 121. First diffused light Lr12 out of first reflected light Lr1 passes through polarizing beam splitter 131 on an as-is basis.

In this manner, in accordance with optical device 200 according to this embodiment, hyperspectral camera 121 receives, out of first reflected light Lrs1, first specularly reflected light Lr11 that has passed through dichroic mirror 150, half-wave plate 242, Faraday rotator 241, and polarizing beam splitter 131 in stated order. As a result, the SN ratio of the image data (spectral data) based on the specularly reflected light from target 190 can be improved as in Embodiment 1.

### Embodiment 3

Next, Embodiment 3 will be described.

An optical device according to Embodiment 3 differs from that according to Embodiment 1 in the configuration of the second imager and in further including a second polarizer. In the description below, differences from Embodiment 1 will be mainly described, and explanations of points in common will be omitted or simplified.

### [3-1. Overview]

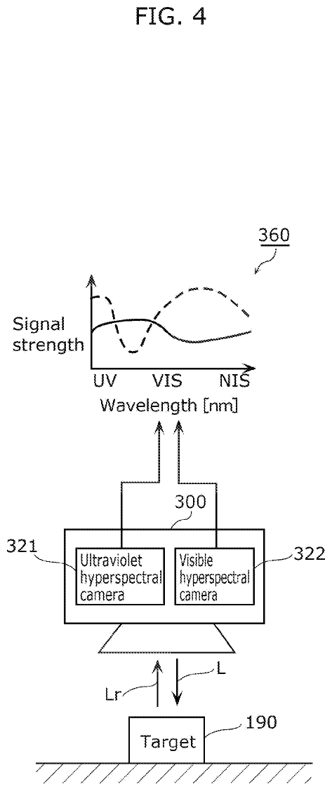

First, the optical device according to Embodiment 3 will be described with reference to FIG. 4. FIG. 4 illustrates an overall configuration of optical device 300 according to this embodiment.

Optical device 300 illustrated in FIG. 4 includes ultraviolet hyperspectral camera 321 and visible hyperspectral camera 322 instead of hyperspectral camera 121 and visible light camera 122 when compared with optical device 100 according to Embodiment 1. That is, optical device 300 includes two hyperspectral cameras sensitive to different wavelength bands.

Optical device 300 generates and outputs object information 360. As does object information 160 according to Embodiment 1, object information 360 indicates, for example, spectroscopy spectra of reflected light Lr in corresponding parts of target 190. Object information 360 indicates spectroscopy spectra in corresponding pixels in wavelength bands wider than those in object information 160. For example, object information 360 includes a visible light band and an infrared light band in addition to an ultraviolet light band.

This allows the composition of target 190 to be analyzed, or foreign substances contained in target 190 to be detected more accurately.

### [3-2. Configuration]

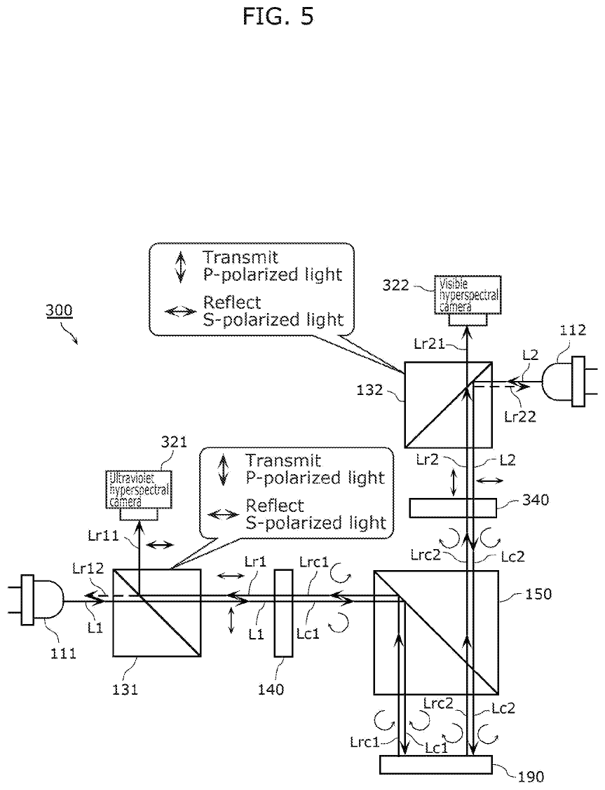

Next, a specific configuration of optical device 300 according to this embodiment will be described with reference to FIG. 5. FIG. 5 illustrates the specific configuration of optical device 300 according to this embodiment.

As illustrated in FIG. 5, optical device 300 further includes quarter-wave plate 340 when compared with optical device 100 illustrated in FIG. 2. Moreover, as has been illustrated in FIG. 4, optical device 300 includes ultraviolet hyperspectral camera 321 and visible hyperspectral camera 322.

Ultraviolet hyperspectral camera 321 is an example of the first imager having a sensitivity to the first wavelength band. For example, ultraviolet hyperspectral camera 321 is the same as hyperspectral camera 121 according to Embodiment 1.

Visible hyperspectral camera 322 is an example of the second imager having a sensitivity to the second wavelength band. Visible hyperspectral camera 322 is an example of the multispectral camera that obtains the intensity of incident light in each wavelength band. The number of wavelength bands (that is, the number of bands) visible hyperspectral camera 322 can obtain is, for example, 10 or more and may be 100 or more. The widths of the wavelength bands are, for example, 10 nm or less and may be 5 nm or less. Visible hyperspectral camera 322 can obtain image data for each wavelength band. Visible hyperspectral camera 322 can also obtain spectroscopy spectra in corresponding pixels on the basis of the image data.

Combining image data (spectral data) obtained by ultraviolet hyperspectral camera 321 and that obtained by visible hyperspectral camera 322 can produce, for example, object information 360 illustrated in FIG. 4. Note that, as indicated in object information 360, one of ultraviolet hyperspectral camera 321 or visible hyperspectral camera 322 may also have a sensitivity to an infrared light band.

Quarter-wave plate 340 is an example of the second polarizer that changes the polarization state of light that passes through. Specifically, quarter-wave plate 340 has the same function as quarter-wave plate 140. Quarter-wave plate 340 is disposed between polarizing beam splitter 132 and dichroic mirror 150 in the optical path of second light L2.

### [3-3. Optical Paths]

Next, the optical paths of light inside optical device 300 will be described with reference to FIG. 5. Note that the first light and the first reflected light are the same as in Embodiment 1. Therefore, the second light and the second reflected light will be described below.

As illustrated in FIG. 5, second light L2 emitted from second light source 112 and passing through polarizing beam splitter 132 passes through quarter-wave plate 340 to be converted into circularly polarized second light Lc2. Circularly polarized second light Lc2 passes through dichroic mirror 150 and is emitted to target 190.

Circularly polarized second light Lc2 is reflected by target 190. The reflection causes second reflected light Lrc2 to be generated from target 190. Second reflected light Lrc2 includes circularly polarized light. However, the rotation direction of the circularly polarized light is opposite to that of second light Lc2. The circularly polarized light included in second reflected light Lrc2 is a component resulting from specular reflection (that is, specularly reflected light) from target 190.

Note that second reflected light Lrc2 also includes a component resulting from diffuse reflection (that is, diffused light) from target 190. Diffuse reflection causes light to be polarized irregularly, causing the polarization state of the diffused light included in second reflected light Lrc2 to be random.

After passing through dichroic mirror 150, second reflected light Lrc2 passes through quarter-wave plate 340. The circularly polarized light included in second reflected light Lrc2 is converted into linearly polarized light. At this moment, the rotation direction of the circularly polarized light included in second reflected light Lrc2 is opposite to that of second light Lc2. Accordingly, second reflected light Lr2 that has passed through quarter-wave plate 340 includes P-polarized light as specularly reflected light. Note that the polarization state of the diffused light included in second reflected light Lrc2 remains random after the diffused light passes through quarter-wave plate 340, and the diffused light includes, for example, S-polarized light.

Second reflected light Lr2 exiting from quarter-wave plate 340 enters polarizing beam splitter 132. Second specularly reflected light Lr21, which is P-polarized light, out of second reflected light Lr2 passes through polarizing beam splitter 132 on an as-is basis and enters visible hyperspectral camera 322. Second diffused light Lr22 out of second reflected light Lr2 is reflected from polarizing beam splitter 132. Second diffused light Lr22 is emitted to second light source 112 and absorbed by, for example, the inner surface of optical device 300.

In this manner, visible hyperspectral camera 322 receives, out of second reflected light Lr2, light that has passed through dichroic mirror 150, quarter-wave plate 340, and polarizing beam splitter 132 in stated order. Specifically, only second specularly reflected light Lr21, which is the component resulting from the specular reflection from target 190, enters visible hyperspectral camera 322, allowing spectral analysis based on second specularly reflected light Lr21 to be performed. As a result, the SN ratio of the image data (spectral data), based on the specularly reflected light from target 190, obtained by visible hyperspectral camera 322 can also be improved.

### Embodiment 4

Next, Embodiment 4 will be described.

An optical device according to Embodiment 4 differs from that according to Embodiment 3 in the configuration of the two polarizers. In the description below, differences from Embodiment 3 will be mainly described, and explanations of points in common will be omitted or simplified.

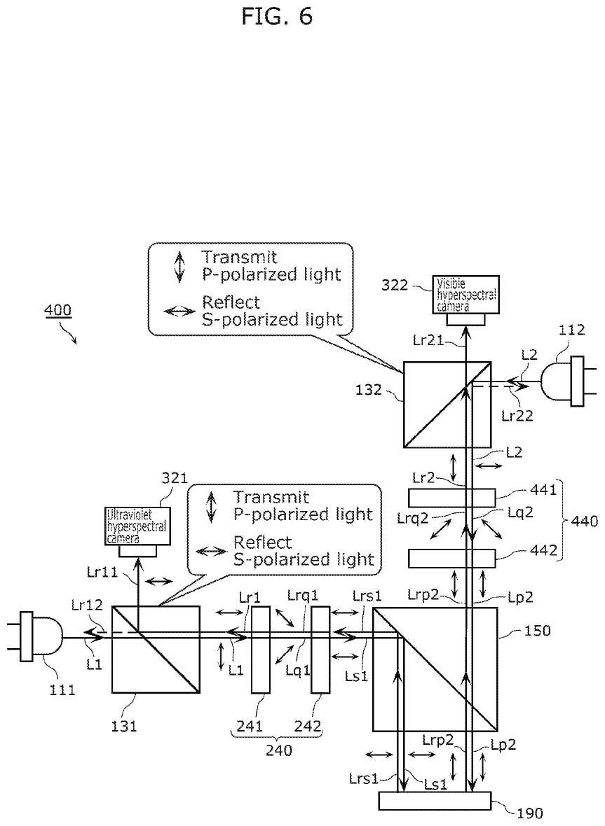

FIG. 6 illustrates a specific configuration of optical device 400 according to this embodiment. As illustrated in FIG. 6, optical device 400 includes polarizers 240 and 440 instead of quarter-wave plates 140 and 340 when compared with optical device 300 illustrated in FIG. 5.

Polarizer 240 is the same as polarizer 240 included in optical device 200 according to Embodiment 2.

Polarizer 440 is an example of the second polarizer that changes the polarization state of light that passes through. Polarizer 440 includes Faraday rotator 441 and half-wave plate 442. Faraday rotator 441 and half-wave plate 442 are disposed in the optical path of second light L2 in stated order.

Faraday rotator 441 is an example of a second Faraday rotator and has the same function as Faraday rotator 241. Specifically, as illustrated in FIG. 6, second light L2 passes through Faraday rotator 441 to be converted into second light Lq2 rotated 45° clockwise. In contrast, second reflected light Lrq2 entering from the opposite direction passes through Faraday rotator 441 to be converted into second reflected light Lr2 rotated 45° counterclockwise.

Half-wave plate 442 is an example of a second half-wave plate and has the same function as half-wave plate 242. Specifically, as illustrated in FIG. 6, second light Lq2 passes through half-wave plate 442 to be converted into second light Lp2 rotated 45° clockwise. In contrast, second reflected light Lrp2 entering from the opposite direction is converted into second reflected light Lrq2 rotated 45° clockwise, which is the same rotation direction.

As described in Embodiment 2, replacing quarter-wave plate 140 according to Embodiment 1 with Faraday rotator 241 and half-wave plate 242 produces effects equal to those in Embodiment 1. Similarly, replacing quarter-wave plate 340 according to Embodiment 3 with Faraday rotator 441 and half-wave plate 442 produces effects equal to those in Embodiment 3.

### Other Embodiments

Although optical devices according to one or more aspects have been described above on the basis of the foregoing embodiments, these embodiments are not intended to limit the present disclosure. The scope of the present disclosure encompasses forms obtained by various modifications, to the embodiments, that can be conceived by those skilled in the art and forms obtained by combining elements in different embodiments without departing from the spirit of the present disclosure.

For example, the optical devices according to the embodiments may include one or more optical members, such as mirrors or lenses, that can change the optical paths of light. For example, one or more mirrors that specularly reflect light may be disposed between the light sources and polarizing beam splitters. Alternatively, one or more optical members may be disposed between the cameras and the polarizing beam splitters, between the polarizing beam splitters and the dichroic mirror, between the polarizing beam splitters and the quarter-wave plates or the Faraday rotators, between the half-wave plates and the dichroic mirror, or between the Faraday rotators and the half-wave plates, for example. As flexibility in designing the optical paths increases, flexibility in arranging members included in the optical devices increases. This contributes to a reduction in the size of the optical devices.

Moreover, for example, in Embodiment 4, polarizers 240 and 440 do not need to include Faraday rotators 241 and 441, respectively. That is, polarizers 240 and 440 may only include half-wave plates 242 and 442, respectively. In this case, optical device 400 includes a polarizing beam splitter, which is an example of the beam splitter, instead of dichroic mirror 150.

In this case, the polarizing beam splitter is inclined at 45° to reflect linearly polarized light resulting from P-polarized light rotated 45° clockwise and to transmit linearly polarized light resulting from S-polarized light rotated 45° clockwise. Alternatively, polarizing beam splitters 131 and 132 may be inclined at 45° in the same direction.

Moreover, various modifications, substitutions, additions, omissions, and the like can be made to the embodiments above within the scope of the claims or equivalents thereof.

### INDUSTRIAL APPLICABILITY

The present disclosure can be used as optical devices that can produce multiple images with little image misalignment and with reduced noise, and can be used for, for example, devices for inspecting articles.

1. An optical device comprising:
a first light source that emits first light in a first wavelength band;
a second light source that emits second light in a second wavelength band different from the first wavelength band;
a first polarizing beam splitter;
a second polarizing beam splitter;
a beam splitter;
a first polarizer that changes a polarization state of light that passes through,
a first imager having a sensitivity to the first wavelength band; and
a second imager having a sensitivity to the second wavelength band, wherein
the first polarizing beam splitter, the first polarizer, and the beam splitter are disposed in an optical path of the first light in stated order,
the second polarizing beam splitter and the beam splitter are disposed in an optical path of the second light in stated order,
the first imager receives, out of first reflected light, light that has passed through the beam splitter, the first polarizer, and the first polarizing beam splitter in stated order, the first reflected light resulting from the first light that has exited from the beam splitter being reflected from an object,
the second imager receives, out of second reflected light, light that has passed through the beam splitter and the second polarizing beam splitter in stated order, the second reflected light resulting from the second light that has exited from the beam splitter being reflected from the object, and
the beam splitter transmits one of a pair of the first light and the first reflected light or a pair of the second light and the second reflected light, and reflects an other pair of the pair of the first light and the first reflected light or the pair of the second light and the second reflected light.

2. The optical device according to claim 1, wherein
the beam splitter is a dichroic mirror that has a reflection band that is the first wavelength band and a transmission band that is the second wavelength band.

3. The optical device according to claim 1, wherein
the first polarizer is a quarter-wave plate.

4. The optical device according to claim 1, wherein
the first polarizer includes a first Faraday rotator and a first half-wave plate, and
the first Faraday rotator and the first half-wave plate are disposed in the optical path of the first light in stated order.

5. The optical device according to claim 1, wherein
the first imager is a multispectral camera.

6. The optical device according to claim 1, wherein
the second imager is a camera having a sensitivity to visible light.

7. The optical device according to claim 1, further comprising:
a second polarizer that changes a polarization state of light that passes through, wherein
the second polarizer is disposed between the second polarizing beam splitter and the beam splitter in the optical path of the second light.

8. The optical device according to claim 7, wherein
the second polarizer is a quarter-wave plate.

9. The optical device according to claim 7, wherein
the second polarizer includes a second Faraday rotator and a second half-wave plate, and
the second Faraday rotator and the second half-wave plate are disposed in the optical path of the second light in stated order.

10. The optical device according to claim 7, wherein
the second imager is a multispectral camera.
